(19) United States
(12) Patent Application Publication
(10) Pub. No.: US 2004/0019548 A1
(43) Pub. Date: Jan. 29, 2004

(54) Security evaluating system and method thereof

(76) Inventors: Kenneth Hu, San Gabriel, CA (US); Tzy-Kang Hu, San Gabriel, CA (US)

Correspondence Address: Raymond Y. Chan, Suite 128, 108 N. Ynex Ave., Monterey Park, CA, 91754, US

(21) Appl. No.: 10/201,822

(22) Filed: Jul. 25, 2002

(51) Int. Cl. G06F 17/60

(52) U.S. Cl. 705/36

(57) ABSTRACT

A securities evaluating system includes a central processing device, an input device linked to the central processing device to receive security parameters of a trade order in the central processing device, the security parameter including a security to be traded, a trading price of the security, a fund to be committed, a quantity of the share of the security, and a cost of the trade order, wherein one of the security parameters is set as an unknown parameter, and a displaying device for displaying the security parameters of the trade order including the unknown parameter, wherein the unknown parameter of the trade order is evaluated based upon the security parameters input in the central processing device.

### BACKGROUND OF THE PRESENT INVENTION

1. Field of Invention

The present invention relates to a security trading activity, and more particularly to a security evaluating system and a method thereof, which allows one to effectively manage the personal portfolio during the stock trading activity, so as to minimize the risk thereof.

2. Description of Related Arts

Tradable security includes bonds, mutual funds, stocks, options, and etc . . . during security trading activity, traders always desire to buy the securities at the lowest prices and sell them at the highest prices.

Due to the advent of information technology, today the stock and security information, such as security quotes, is vastly available through the mass communications such as television, radio, newspaper, or Internet. Therefore, the traders are able to monitor the securities market and buy and sell stocks and other securities easily. Especially through the wireless communication network such as Internet, the traders can get access to literally thousands of investment services, publications, newsletters, and discussion groups which are just a button click away. Therefore, Internet traders continue to grow rapidly.

However, even though the security quotes are readily available, while the traders may know how much they are willing to invest in particular stocks or securities, they still need to perform some simple mathematics to calculate how many shares or units they can afford before the orders or trades can be placed. Especially when the traders need to sell the holding securities and buy another securities for their portfolios, they must get the prices for all the desired securities to calculate how many shares or units of the holding securities must be sold in order to have enough cash or fund to buy the intended securities. However, in the volatile market, the prices they used to calculate might already be distant from the real market prices. Thus, errors may occur if the calculation results, the data deducted from the market prices which might already become outdated in a fast changing market when applied, are later used for placing trades. In particular, it may result in exceeding their purchasing power. A delay of timing may cause a trade to be placed at an inopportune moment.

Moreover, the price of any tradable security may not be an exact integer. Mostly, securities quotes are decimalized, so that the traders must be carefully calculate the shares or units of the security that they can afford to buy and sell without exceeding their purchasing power. Sometimes, the decimal fraction of the price of the security may cause the failure of the purchasing plan of the trader, especially when a large amount of shares of the intended security will be purchased. It is worth mentioning that the sequences for the trader to sell the holding security first and then buy the intended security or to buy the intended security and then sell the holding security can lead to have different results. In other words, the first trade of the security will directly affect the next trade of the security.

### SUMMARY OF THE PRESENT INVENTION

A main object of the present invention is to provide a securities evaluating system, which allows one to effectively manage the portfolio during the stock trading activity. An investor is able to customizing a personnel investment portfolio that includes the cash asset and all the tradable securities. According to the investment portfolio, the investor can supervise the investment plan before performing the security trading activity.

Another object of the present invention is to provide a securities evaluating system, which is handy that the investor is able to carry the present invention anywhere for calculating each single trade order.

Another object of the present invention is to provide a securities evaluating system, wherein the investor is able to preset the cash reserve in the investment portfolio for immediately determining the purchasing power, in such a manner that the investor is able to make a quick decision of how much he or she can trade without exceeding his or her purchasing power.

Another object of the present invention is to provide a securities evaluating system, wherein the market value and the equity, or the net worth, of the personal investment portfolio can be updated in real time or periodically, so that all the intended trades will be automatically recalculated to reflect the price changes. Therefore, the investor is able to more accurately invest the capital in the stock market.

Another object of the present invention is to provide a securities evaluating method, which allows one to precisely calculate the hypothetical equity, such that the investor is able to eliminate the complex manual calculation and reduce the errors made during calculation.

Another object of the present invention is to provide a securities evaluating method, which is a convenient tool for the security investors to allocate their portfolios, so as to effectively invest their capital in the security markets to minimize the risk during the security trading activity.

Another object of the present invention is to provide a securities evaluating method, wherein the calculating operation of the present invention is simple and quick that one can input the price and the quantity of the intended trade to get the quote of the intended trade immediately.

Accordingly, in order to accomplish the above objects, the present invention provides a securities evaluating system, which comprises:

a central processing device,

an input device linked to the central processing device for receiving security parameters of a trade order into the central processing device, the security parameter including a security to be traded, a trading price of the security, a fund to be committed, a quantity of the share of the security, and a cost of the trade order, wherein one of the security parameters is set as an unknown parameter; and

means for displaying the security parameters of the trade order including the unknown parameter, wherein the unknown parameter of the trade order is evaluated based upon the security parameters input in the central processing device.

The present invention further provides a securities evaluating method, which comprises the steps of:

(a) inputting at least two security parameters of the trade order wherein the unknown parameter is remained vacant;

(b) producing a security balance by computing the trade order according to the security parameters input in the central processing device; and

(c) evaluating the unknown parameter of the trade order.

### BRIEF DESCRIPTION OF THE DRAWINGS

FIG. 1 illustrates a relationship between a central processing device, an input device, and a displaying means of the security evaluating system according to the above preferred embodiment of the present invention.

FIG. 2 is a flow chart of a securities evaluating method according to the above preferred embodiment of the present invention.

FIG. 3 is a flow chart of the securities evaluating method according to the above preferred embodiment of the present invention, illustrating the security quote being updated real time.

FIG. 4 is a flow chart of the securities evaluating method according to the above preferred embodiment of the present invention, illustrating the security quote being updated periodically.

### DETAILED DESCRIPTION OF THE PREFERRED EMBODIMENT

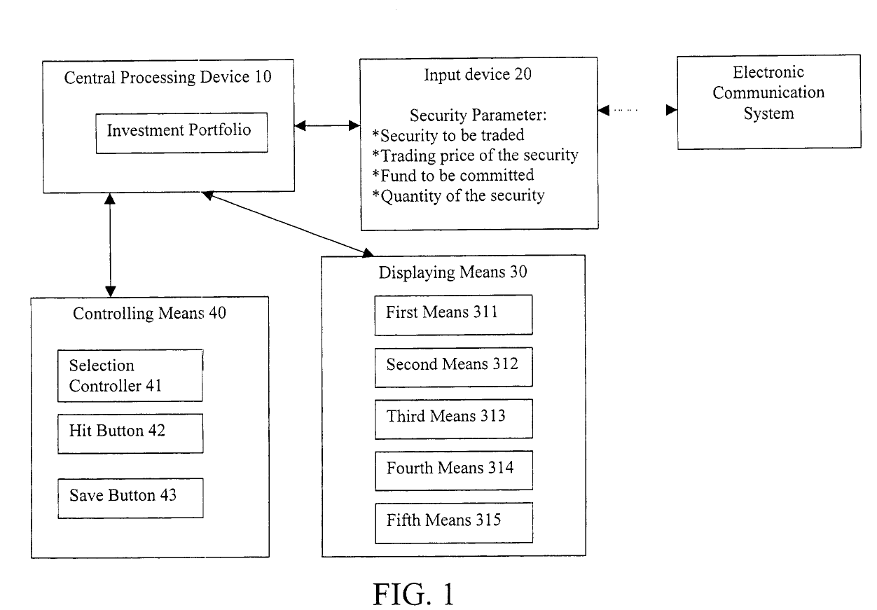

Referring to FIG. 1, a securities evaluating system according to a preferred embodiment of the present invention is illustrated, wherein the securities evaluating system comprises a central processing device 10, an input device 20 linked to the central processing device 10 for receiving security parameters of a trade order by a trader, means 30 for displaying the security parameters of the trade order including an unknown parameter, wherein the unknown parameter of the trade order is evaluated based upon the security parameters input in the central processing device 10.

According to the preferred embodiment, the securities evaluating system is provided in a handy casing 1 such that the trader is able to carry the handy casing 1 anywhere so as to supervise the investment plan before performing the security trading activity.

The central processing device 10 can be either disposed in the handy casing 1 or remotely linked to the input device 20 and displaying means 30 through wired or wireless communication connection. The central processing device 10 is a circuit board to communicatively incorporate the input device 20 with the displaying means 30. Moreover, the central processing device 10 is arranged to perform a computation of the trade order according to the security parameters thereof.

Accordingly, the security parameters of the trade order are represented as a security to be traded, a trading price of the security, a fund to be committed, and a specified quantity of the security respectively. The security parameters of the trade order are entered by the trader through the input device 20 and are saved in the central processing device 10. The security entered through the input device 20 is identified by using the name of the security, a trading symbol of the security that is commonly used, or a specify symbol that preset by the trader. For example, when the security of “Intel” is intended to be traded, the trader is able to enter the security by inputting the full name of “Intel”, a symbol of “intc”, or a symbol of “001” that preset by the trader for representing the security of “Intel”.

After inputting the security parameters into the central processing device 10, the central processing device 10 will calculate the cost of the trade order. The central processing device 10 can also be chose to store the trade permanently for future access.

In which:

Cost=Shares×Price per Share

The displaying means 30, according to the preferable embodiment, is a monitoring screen provided on the handy casing 1. The displaying means 30 comprises first means 311 for displaying the security to be traded, second means 312 for displaying the trading price of the security per share, third means 313 for displaying the fund to be committed, fourth means 314 for displaying the quantity of the share of the security to be traded, and fifth means 315 for the cost of the trade order. As shown in FIG. 1, the first to fifth means 311314 are embodied in the same monitoring screen in such a manner that the security parameter of the trade order is displayed on the single screen in a “spreadsheet format” so that the trader is able to preview the trade order easily.

Moreover, the securities evaluation system further comprises means 40 for controlling the central processing device 10 wherein the controlling means 40 comprises a selection controller 41 electrically linked to the input device 20 to select the security parameter to be input. Accordingly, the selection controller 41, which is embodied as a button, is capable of selectively shifting the input device 20 from screens to screens such that when the first means 311 is selected by the selection controller 41, the trader is able to input the security symbol of the security parameter to the central processing device 10. Likewise, when the third means 313 is selected by the selection controller 41, the trader is able to input the fund of the security parameter to the central processing device 10.

The controlling means 40 further comprises a hit button 42 and a save button 43 electrically linked to the central processing device 10. The hit button 42 is arranged to actuate the central processing device 10 for calculating an evaluation result after the desired security parameters are input. In other words, the trader is able to input the security parameters and then actuate the hit button 42 in order to command the central processing device 10 to perform the calculation according to the input security parameters.

The save button 43 is arranged to actuate the central processing device 10 for saving the evaluation result into the central processing device 10 in such a manner that the trader is able to retrieve the evaluation results saved in the central processing device 10 as a trading record.

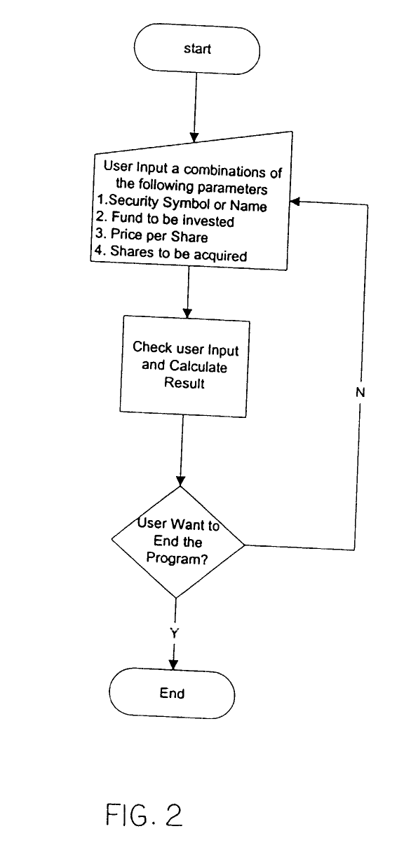

As shown in FIG. 2, the present invention further provides a securities evaluating method which comprises the following steps.

(1) Input at least two security parameters of the trade order wherein the unknown parameter is remained vacant.

(2) Produce a security balance by computing the trade order according to the security parameters input in the central processing device.

(3) Evaluate the unknown parameter of the trade order.

Accordingly, an investment portfolio is preferably stored and saved in the central processing device 10, wherein the investment portfolio is capable of wired or wireless accessing such as Internet when the central processing device 10 is compatibly linked to an electronic communication system. In other words, the trader is able to remotely access the investment portfolio anytime and anywhere through the electronic communication system. However, the central processing device 10 can also be locally stored in an electronic computing device, such as a personal computer, such that the trader is able to access the investment portfolio at home or office without using any communication network such as Internet service provider.

The investment portfolio may include all the tradable securities such as stocks, mutual funds, options or bonds. The market value of the investment portfolio is calculated by multiplying the shares/units of the tradable securities owned by the trader with the market prices at the present time. For example, the initial market value of the investment portfolio is zero because there is no trading activity. When the trader has one hundred shares of stock with the present market price of $20 per share, the market value of the investment portfolio is counted by $20×100=$2000. Therefore, the trading activities are recorded in the investment portfolio so that the trader is able to retrieve the trading record before planning the trade order.

It is worth mentioning that the investment portfolio can be only performed to calculate each of the trade order such that no previous trade order is stored in the investment portfolio. In other words, the investment portfolio can be a computing program for calculating the market value of the security to be traded.

In the step (1), once the investment portfolio is set, the trader is able to input the security parameters of the trade order into the investment portfolio for calculation. In the trade order, the trader must input at least two security parameters in order to perform the calculation.

In the step (2), the security balance including the cost for trade order will be shown in the displaying means 30 in a spreadsheet format. Moreover, the trader is able to selectively adjust the security parameter anytime in the investment portfolio so as to seek for the suitable investment plan that adapts the volatile stock market and the securities markets.

Therefore, the trader is able to evaluate the unknown parameter of the trade order, in step (3), so as to select the optimum investment plan before the trade order is placed in the real securities market.

According to the preferred embodiment, the securities evaluating method in the step (1) further comprises a step of:

(1.1) updating the trading price for the trade order.

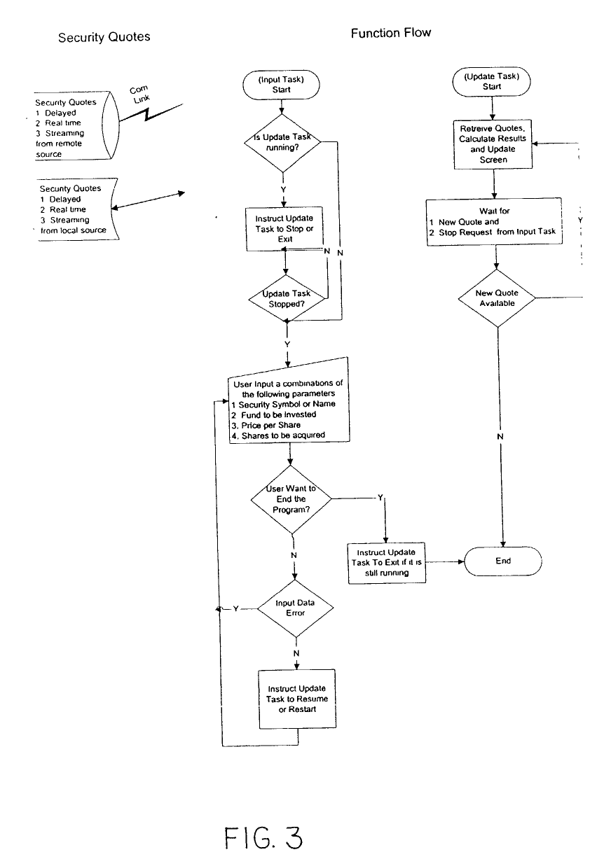

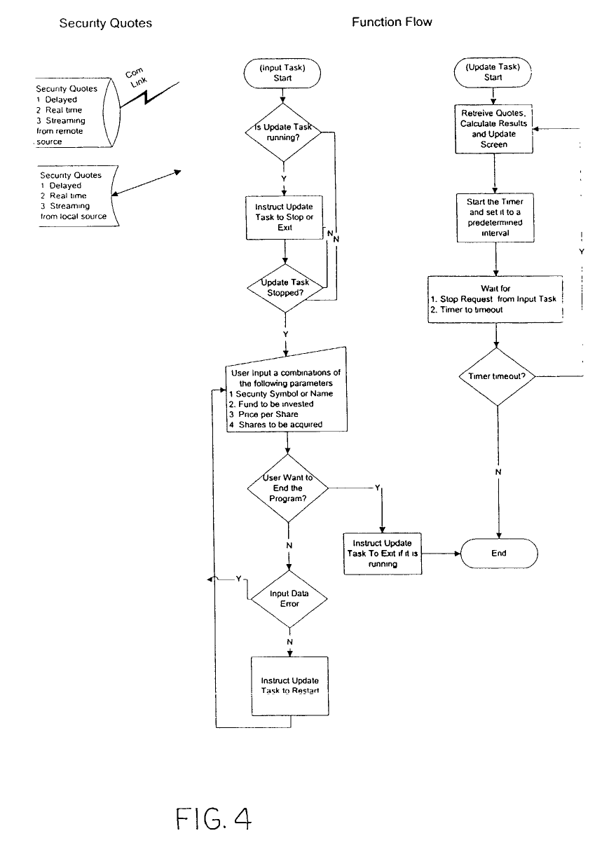

In the step (1.1), the trading price of the security to be traded should be updated to give a most updated and accurate result of the unknown parameter of the trade order. In order to get equity quotes or the updated market prices for all the tradable securities of the investment portfolio, the central processing device 10 is capable of linking to a source of information through the electronic communication system, such as a website from Internet. In other words; the trading price of the security will be updated either in real time or in a period of time preset by the user, as shown in FIGS. 3 and 4. Alternatively, the trader is able to manually input the trading price of the corresponding security anytime in order to update the trading price of the security to be traded.

Preferably, the investment portfolio should be either automatically or manually updated when the trader initially starts to access the investment portfolio in such a manner that the trader is able to analyze the updated information with respect to the securities markets. Otherwise, the updating step can also be performed at the time before the trader places the trade order to give an accurate market price of the trade order.

The following cases illustrate the evaluation results of the unknown parameters when different security parameters are input into the investment portfolio.

Case 1. Parameter Input: Security symbol Only.

The security symbol is displayed on the first means 313. The price of the security can be retrieved from the investment portfolio and displayed on the second means 312. However, an error message is indicated that the unknown parameter of the trade order cannot be determined due to the insufficient security parameter input. The remedy of the error is to request the trader to input more security parameters.

Case 2. Parameter Input: Fund Only

The fund is displayed on the third means 313. However, an error message is indicated that the unknown parameter of the trade order cannot be determined due to the insufficient security parameter input. The remedy of the error is to request the trader to input more security parameters.

Case 3. Parameter Input: (Trading Price) or (Security and Trading Price)

The trading price is displayed on the second means 312. However, an error message is indicated that the unknown parameter of the trade order cannot be determined due to the insufficient security parameter input. The remedy of the error is to request the trader to input more security parameters. Moreover, when the security and the price thereof are input, the automatic quota update is not available for the corresponding security since the trading price is manually input by the trader.

Case 4. Parameter Input: Shares Only

The share of the security to be traded is displayed on the fourth means 314. However, an error message is indicated that the unknown parameter of the trade order cannot be determined due to the insufficient security parameter input. The remedy of the error is to request the trader to input more security parameters.

Case 5. Parameter Input: Fund and Shares

The fund and the share of the security to be traded are displayed on the third and fourth means 313, 314 respectively. The evaluation result according to the security parameters shows the cost of the trade order is the amount of the fund. Moreover, the trading price is calculated by the formula of: Price=Fund/Shares, so as to illustrate the trading price that the trader is sufficient to buy within the fund. For example, when $1000 is input as the fund and 50 shares is input as the shares, the cost of the trade order is shown as $1000 and the trading price is shown as $20. Therefore, according to the evaluation result, the trader is able to buy 50 shares of the security that each share thereof must be below $20.

Case 6. Parameter Input: Security and Shares

The security symbol and the share of the security to be traded are displayed on the first and fourth means 313, 314 respectively. Moreover, the trading price of the security is retrieved. Therefore, the cost of the trade order for the security is calculated by the formula of: Cost=Price×Shares. It is worth mentioning that when the trading price of the security cannot be automatically retrieved, an error message is indicated to ask the trader to input manually.

Case 7. Parameter Input: Security and Fund

The security symbol and the fund are displayed on the first and third means 311, 313 respectively. Moreover, the trading price of the security is retrieved. Therefore, the share of the security can be calculated by the formula of: Share=Fund/Price. In other words, the cost of the trade order is shown as the fund while the shares of the security are capable of buy within the fund. It is worth mentioning that when the trading price of the security cannot be automatically retrieved, an error message is indicated to ask the trader to input manually.

Case 8. Parameter Input: Security, Fund and Shares

The security symbol, the fund, and the shares of the security to be traded are displayed on the first, third, and fourth means 311, 313, 314 respectively. Moreover, the trading price of the security is retrieved. However, a conflict error is indicated that there is a conflict between the fund, shares, and trading price. Therefore, the remedy of the error is to ignore one of the security parameters input into the investment portfolio.

When the retrieved trading price is ignored, a warning message is shown wherein the cost of the trade order is set as the fund and the trading price is re-calculated by the formula of: Price=Fund/Shares. When the fund of the security parameter is ignored, the warning message is shown wherein the cost of the trade order is calculated by the formula of: Cost=Price×Shares. When the shares of the security parameter is ignored, the warning message is shown wherein cost of the trade order is set as the fund and the share is calculated by the formula of: Share=Fund/Price. It is worth mentioning that the trader is able to select which one of the security parameters to be ignored in order to resolve the conflict.

Case 9. Parameter Input: (Price and Shares) or (Security, Price, and Shares)

The trading price and the shares of the security to be traded are displayed on the second and fourth means 312, 314 respectively. The cost of the trade order is calculated by the formula of: Cost=Price×Shares.

Case 10. Parameter Input: Security, Price, and Fund

The security symbol, trading price, and fund are displayed on the first, second, and third means 311, 312, 313 respectively. The cost of the trade order is set as the fund and the shares of the security to be traded is calculated by the formula of: Share=Fund/Price.

Case 11. Parameter Input: Security, Fund, Price, and Shares

The security symbol, trading price, fund, and shares of the security to be traded are displayed on the first, second, third, and fourth means 311, 312, 313, 314 respectively. However, as mentioned in the case 8, the conflict error is indicated that there is a conflict between the security, fund, shares, and trading price. Therefore, the remedy of the error is to ignore at least one of the security parameters input into the investment portfolio.

When the fund of the security parameter is ignored, the warning message is shown wherein the cost of the trade order is calculated by the formula of: Cost=Price×Shares. When the shares of the security parameter is ignored, the warning message is shown wherein cost of the trade order is set as the fund and the share is calculated by the formula of: Share=Fund/Price. When the retrieved trading price and the trading price of the security parameter are ignored, a warning message is shown wherein the cost of the trade order is set as the fund and the trading price is re-calculated by the formula of: Price=Fund/Shares. It is worth mentioning that the trader is able to select which one of the security parameters to be ignored in order to resolve the conflict.

Case 12. Parameter Input: None

None of the security parameter will be displayed and an error message is indicated that the unknown parameter of the trade order cannot be determined due to the insufficient security parameter input. The remedy of the error is to request the trader to input more security parameters.

What is claimed is:

1. A securities evaluating system, comprising:
a central processing device storing security parameters,
an input device linked to said central processing device to receive said security parameters of a trade order in said central processing device, said security parameters representing as a security to be traded, a trading price of said security per share, a fund to be committed, a quantity of said share of said security, and a cost of said trade order, wherein one of said security parameters is set as an unknown parameter; and
means for displaying said security parameters of said trade order including said unknown parameter, wherein said unknown parameter of said trade order is evaluated based upon said security parameters input in said central processing device.

2. A securities evaluating system, as recited in claim 1, wherein said displaying means comprises first means for displaying said security to be traded, second means for displaying said trading price of said security per share, third means for displaying said fund to be committed, fourth means said for displaying said quantity of said share of said security to be traded, and fifth means for said cost of said trade order, wherein after said security parameters are input in said central processor, said security parameters are displayed on said corresponding display means respectively.

3. A securities evaluating system, as recited in claim 1, is performed by a securities evaluating method which comprises the steps of:
(a) inputting at least two said security parameters of said trade order through said input device wherein said unknown parameter is remained vacant;
(b) producing a security balance by computing said trade order through said central processing device according to said security parameters input in said central processing device; and
(c) evaluating said unknown parameter of said trade order.

4. A securities evaluating system, as recited in claim 2, is performed by a securities evaluating method which comprises the steps of:
(a) inputting at least two said security parameters of said trade order through said input device wherein said unknown parameter is remained vacant;
(b) producing a security balance by computing said trade order through said central processing device according to said security parameters input in said central processing device; and
(c) evaluating said unknown parameter of said trade order.

5. A securities evaluating system, as recited in claim 3, wherein the step (a) further comprise a step of updating said trading price of said security to be traded to give a most updated and accurate result of said unknown parameter of said trade order.

6. A securities evaluating system, as recited in claim 4, wherein the step (a) further comprise a step of updating said trading price of said security to be traded to give a most updated and accurate result of said unknown parameter of said trade order.

7. A securities evaluating system, as recited in claim 5, wherein in order to obtain said updated trading price for each of said securities, said input device is linked to a source of information through electronic communication system.

8. A securities evaluating system, as recited in claim 6, wherein in order to obtain said updated trading price for each of said securities, said input device is linked to a source of information through electronic communication system.

9. A securities evaluating system, as recited in claim 3, wherein an error message is indicated when said unknown parameter of said trade order is unable to be determined due to an insufficient security parameter input.

10. A securities evaluating system, as recited in claim 6, wherein an error message is indicated when said unknown parameter of said trade order is unable to be determined due to an insufficient security parameter input.

11. A securities evaluating system, as recited in claim 8, wherein an error message is indicated when said unknown parameter of said trade order is unable to be determined due to an insufficient security parameter input.

12. A securities evaluating method, comprising the step of:
(a) inputting at least two said security parameters of a trade order through a input device, while an unknown parameter is remained vacant, said security parameters representing as a security to be traded, a trading price of said security per share, a fund to be committed, a quantity of said share of said security, and a cost of said trade order, wherein one of said security parameters is set as said unknown parameter;
(b) producing a security balance by computing said trade order through a central processing device according to said security parameters input in said central processing device; and
(c) evaluating said unknown parameter of said trade order.

13. The method, as recited in claim 12, wherein the step (a) further comprise a step of updating said trading price of said security to be traded to give a most updated and accurate result of said unknown parameter of said trade order.

14. The method, as recited in claim 12, after the step (c) further comprising a step of displaying said security parameters including said unknown parameter.

15. The method, as recited in claim 13, after the step (c) further comprising a step of displaying said security parameters including said unknown parameter.

16. The method, as recited in claim 12, further comprising a step of indicating an error message when said unknown parameter of said trade order is unable to be determined due to an insufficient security parameter input.

17. The method, as recited in claim 15, further comprising a step of indicating an error message when said unknown parameter of said trade order is unable to be determined due to an insufficient security parameter input.

18. The method, as recited in claim 15, further comprising a step of indicating an error message when said unknown parameter of said trade order is unable to be determined due to an insufficient security parameter input.

19. The method, as recited in claim 12, wherein said central processing device is installed into an electronic computing device so that a user is able to access said central processing device through said electronic computing device.

20. The method, as recited in claim 18, wherein said central processing device is installed into an electronic computing device so that a user is able to access said central processing device through said electronic computing device.
